(19) United States
(12) Patent Application Publication
(10) Pub. No.: US 2018/0100449 A1
(43) Pub. Date: Apr. 12, 2018

(54) OPERATING A GASEOUS FUEL INJECTOR

(71) Applicant: WESTPORT POWER INC., Vancouver (CA)

(72) Inventors: Alan B. WELCH, Vancouver (CA); Colin W. BLAIR, White Rock (CA); Hamed KARIMI SHARIF, Vancouver (CA)

(21) Appl. No.: 15/565,034

(22) PCT Filed: Apr. 7, 2016
(86) PCT No.: PCT/CA2016/050401

§ 371 Date: Oct. 6, 2017

(30) Foreign Application Priority Data
Apr. 7, 2015 (CA) 2887730

(51) Int. Cl. F02D 19/02; F02D 41/00; F02D 41/22

(52) U.S. Cl. CPC F02D 19/024; F02D 19/026; F02D 19/0642; F02D 41/221; F02D 41/0027

(57) ABSTRACT

Fuel injection accuracy of gaseous fuel injectors is important for efficient engine operation. However, the performance of the injectors varies from part to part and across their lifetime, and when an injector is under performing according to its specification it is often unknown what is causing the problem. An apparatus for operating a gaseous fuel injector in an engine comprises a mass flow sensor that generates a signal representative of the mass flow rate of the gaseous fuel in a supply conduit in the engine. A controller connected with the injector and the mass flow sensor is programmed to actuate the injector to introduce gaseous fuel into the engine; determine the actual mass flow rate of the gaseous fuel based on the signal representative of the mass flow rate; calculate a difference between the actual mass flow rate and a desired mass flow rate; and adjust at least one of on-time of the gaseous fuel injector and a magnitude of an injector activation signal by respective amounts based on the difference when the absolute value of the difference is greater than a predetermined value.

### FIELD OF THE INVENTION

The present application relates to an apparatus and method for operating a gaseous fuel injector in an internal combustion engine.

### BACKGROUND OF THE INVENTION

Gaseous fuel injectors are known to use solenoid actuators to move a plunger or disc style armature to open an injection valve. The armature has a rubber seal (also known as a shutter) that dynamically seals around a valve seat when the injection valve is closed. These types of gaseous fuel injectors have very low leakage and wear, allowing for a very long service life, and are relatively inexpensive to produce. To balance part-to-part injector performance, the stroke of the injector is normally limited to a lower value than that which gives maximum mass flow so that the injectors can be balanced by adjusting the exact stroke on the production line. The injector is flow-limited in an area under the armature when the ratio between armature lift (stroke length) and valve orifice area is relatively small. As these injectors age, or even when relatively new, mechanical, chemical and electromagnetic differences will affect relative static and dynamic behavior of the armature motion and injection valve performance. Electromagnetic differences can result from a variety of reasons, including dimensional differences in the injection valve components, air-gaps, coil windings, seal volume, wire harness resistance, chemical swelling of elastomers and pin electrical resistance contact variances. The differences in injector performance has been observed, both on test rigs and with parts returned from the field for servicing, to cause large fuel delivery variations, particularly between injectors. Often these affects are very noticeable at low pulse width conditions where the linearity of injection performance is reduced as a result of the plunger bouncing when the injection valve is opened. Also, during cold starting, trace oil, water and wear particles that accumulate in between moving parts (such as between the plunger and the injector body or tube, between the armature seal and the valve seat, and the return spring) may cause the injectors to respond in a “sluggish manner” or not at all. This is due to increased viscous drag, surface tension or even solidification (amorphous, crystalline) of these “contaminants” that are normally in liquid phase at room temperature and at typical operating temperatures of about 40° C. with a warm engine.

Previous attempts to improve part-to-part balancing in injector performance included precision injector calibration on flow rigs during manufacturing. However, as the injectors wear, parts change shape due to chemical swelling or uneven accumulation of contaminants, and the precision calibration can be greatly compromised. Fuel injector actuation issues can be mitigated (to a limited degree) by use of very strong magnetic opening forces, which can help to partially overcome resistance to motion or “stickiness” at the plunger/tube and valve seal/seat interfaces. However, stronger magnetic forces typically require higher peak coil current in the fuel injector actuator, which increases electrical energy consumption and reduces overall engine efficiency. In addition, using a coalescing filter upstream of fuel injectors reduces the amount of oil, water and dirt getting into the injectors. Contaminants can be in the gaseous fuel for a variety of reasons, such as oil from compressors that are employed to pressurize the gaseous fuel. Unfortunately, the necessary servicing of filters in the field cannot be guaranteed and the use of filters to reduce contaminants from reaching the injectors (and improving injector performance as a result) has had limited success. During cold start, engines that can be fuelled with gasoline and/or compressed natural gas (CNG) can avoid the “stickiness” of the gaseous fuel injectors by temporarily starting and running on gasoline to allow the engine to warm-up and reduce viscosity of the contaminants, and then switch to CNG after the engine has warmed up. These approaches do not directly deal with the root issue which is open-loop variability with injector age and low temperature (cold start) and low voltage (battery voltage) fuel injector operation.

The state of the art is lacking in techniques for improving injection accuracy for gaseous fuel injectors. The present apparatus and method provides a technique for operating a gaseous fuel injector in internal combustion engines.

### SUMMARY OF THE INVENTION

An improved apparatus for operating a gaseous fuel injector in an internal combustion engine comprises a supply of gaseous fuel and a conduit delivering gaseous fuel to the gaseous fuel injector from the supply of gaseous fuel. A mass flow sensor is associated with the conduit and generates a signal representative of the mass flow rate of the gaseous fuel. A controller is operatively connected with the gaseous fuel injector and the mass flow sensor and is programmed to actuate the gaseous fuel injector to introduce gaseous fuel into the internal combustion engine; determine the actual mass flow rate of the gaseous fuel based on the signal representative of the mass flow rate; calculate a difference between the actual mass flow rate and a desired mass flow rate; and adjust at least one of on-time of the gaseous fuel injector and a magnitude of an injector activation signal by respective amounts based on the difference when the absolute value of the difference is greater than a predetermined value.

In an exemplary embodiment the gaseous fuel injector is located to introduce the gaseous fuel directly into a cylinder of the internal combustion engine. The controller can be further programmed to adjust at least one of the on-time and the magnitude during the same cycle as the determination of the actual mass flow rate. The controller can be further programmed to report performance of the gaseous fuel injector in a diagnostic system, wherein the performance comprises at least one of the actual mass flow rate, a rate of increase of the actual mass flow rate, a leaking indication, an under-flowing indication and an over-flowing indication.

In a preferred embodiment, the mass flow sensor comprises a membrane; first and second temperature sensors arranged on a sensing surface of the membrane; and a heater connected with the membrane and arranged between the first and second temperature sensors. The controller can be operatively connected with the first and second temperature sensors to receive the signals representative of the mass flow rate of the gaseous fuel. In an exemplary embodiment, the controller is a first controller, and the mass flow sensor further comprises a second controller operatively connected with the first controller and the first and second temperature sensors. The second controller is programmed to receive temperature information from the first and second temperature sensors and to transmit the signals representative of the mass flow rate of the gaseous fuel to the first controller.

The mass flow sensor can be located within the conduit. There can be one of a flow redirecting conduit operatively arranged with the mass flow sensor to redirect a portion of gaseous fuel flow in the conduit to the mass flow sensor; and a locating member to space mass flow sensor apart from an inner surface of the conduit. Alternatively, there can be a sampling conduit adjacent to and in fluid communication with the conduit, such that the mass flow sensor is mounted within the sampling conduit, and a flow redirecting member in the conduit to redirect a portion of gaseous fuel flow to the sampling conduit.

An improved method for operating a gaseous fuel injector in an internal combustion engine comprises actuating the gaseous fuel injector to inject gaseous fuel; measuring actual mass flow rate of the gaseous fuel upstream from the gaseous fuel injector; calculating a difference between the actual mass flow rate and a desired mass flow rate; and adjusting at least one of on-time of the gaseous fuel injector and a magnitude of an injector activation signal by respective amounts based on the difference when the absolute value of the difference is greater than a predetermined value. The gaseous fuel can include at least one of biogas, butane, ethane, hydrogen, landfill gas, methane, natural gas, propane, and combinations of these fuels.

In an exemplary embodiment, the on-time and the magnitude can be adjusted during the same cycle as the measurement of the actual mass flow rate. When the actual mass flow rate is below a predetermined mass flow rate value, the method further includes increasing at least one of the on-time of the injector and the magnitude of the activation signal until the actual mass flow rate is above the predetermined mass flow rate value. The method can include determining the rate of increase in actual mass flow rate when the gaseous fuel injector is actuated; and determining that the opening of the gaseous fuel injector is slow when the rate of increase is below a predetermined value; such that the at least one of the on-time and the magnitude of the gaseous fuel injector activation signal is adjusted to compensate for the slow opening of the gaseous fuel injector. The method can further include reporting performance of the gaseous fuel injector in a diagnostic system, where the performance includes at least one of the actual mass flow rate, the rate of increase of the actual mass flow rate, a leaking indication, an under-flowing indication and an over-flowing indication. The method includes heating a space in the flow of gaseous fuel; measuring an upstream temperature and a downstream temperature; and calculating the actual mass flow rate as a function of a difference between the upstream temperature and the downstream temperature. The method can include redirecting a portion of gaseous fuel flow in a gaseous fuel conduit towards a sensing surface of a gaseous fuel mass flow sensor.

In another exemplary embodiment a plurality of gaseous fuel injectors are operated. The method further includes calculating an average mass flow rate as a function of the actual mass flow rates for each gaseous fuel injector; and for each gaseous fuel injector at least one of determining whether the gaseous fuel injector is under-flowing such that the actual mass flow rate is less than the average mass flow rate by a predetermined margin; and determining whether the gaseous fuel injector is over-flowing such that the actual mass flow rate is greater than the average mass flow rate by a predetermined margin. The method can further include determining whether a pressure regulator is under-flowing gaseous fuel when the actual mass flow rates for each injector are equal to within a predetermined range of tolerance and less than a desired mass flow rate by a predetermined value; and reporting the performance of the pressure regulator in a diagnostic system.

### BRIEF DESCRIPTION OF THE DRAWINGS

FIG. 1 is a schematic view of an internal combustion engine according to a first embodiment.

FIG. 2 is a cross-sectional view of a gaseous fuel mass flow sensor according to one embodiment, illustrated with no mass flow of gaseous fuel over a sensing surface.

FIG. 3 is a cross-sectional view of the gaseous fuel mass flow sensor of FIG. 2 illustrated with mass flow of gaseous fuel over the sensing surface.

FIG. 4 is a cross-sectional view of the gaseous fuel mass flow sensor of FIG. 2 spaced apart from a wall of a conduit.

FIG. 5 is a cross-sectional view of the gaseous fuel mass flow sensor of FIG. 2 mounted on a wall of a conduit and employing a redirecting conduit to sample gaseous fuel mass flow away from the wall.

FIG. 6 is a cross-sectional view of the gaseous fuel mass of FIG. 2 mounted in a sampling conduit adjacent to and in fluid communication with a gaseous fuel conduit.

FIG. 7 is a flow chart view of a method for improving injection performance of a gaseous fuel injector according to a first embodiment.

FIG. 8 is a flow chart view of a method for improving injection performance of a gaseous fuel injector according to a second embodiment.

### DETAILED DESCRIPTION OF PREFERRED EMBODIMENT(S)

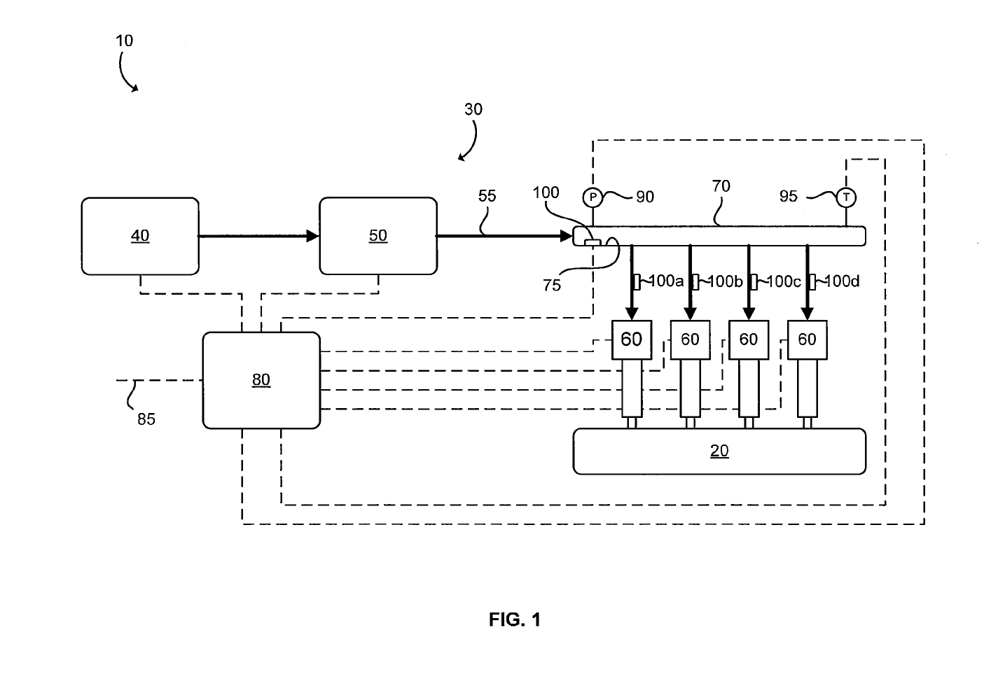

Referring to FIG. 1, there is shown internal combustion engine system 10 according to one embodiment where engine 20 consumes at least a gaseous fuel. Engine 20 can be a monofuel engine that consumes only a gaseous fuel. Alternatively, engine 20 can be a dual fuel engine or a bi-fuel engine that consumes two fuels where at least one of those fuels is a gaseous fuel. A dual fuel engine is defined herein to be an engine that has a dual fuel operational mode where it consumes two fuels simultaneously for a majority of engine operating conditions. A bi-fuel engine is defined herein to be an engine that can consume two fuels, but normally consumes only one of the fuels at a time over the range of engine operating conditions, but can have periodic operation where it consumes both fuels simultaneously. A gaseous fuel is defined herein to be a fuel that is in the gas state at standard temperature and pressure, which in the context of this application is defined to be 20 degrees Celsius (° C.) and 1 atmosphere (atm). Examples of gaseous fuels include biogas, butane, ethane, hydrogen, landfill gas, methane, natural gas, propane and mixtures of these fuels.

In the illustrated embodiment only fuel supply system 30 for the gaseous fuel is illustrated, and as would be known by those familiar with the technology another fuel supply system is required for the second fuel (liquid or gaseous) when engine 20 is a dual fuel or bi-fuel engine. Gaseous fuel supply 40 stores a gaseous fuel and supplies the gaseous fuel to pressure regulator 50. Gaseous fuel supply 40 can supply the gaseous fuel to pressure regulator 50 at or above a predetermined pressure within a range of tolerance, although this is not a requirement. For example, when gaseous fuel supply 40 stores the gaseous fuel in liquefied form (such as liquefied natural gas) it can pressurize the gaseous fuel (that is, pump the fuel) and increase its enthalpy by transferring heat to the fuel through a heat exchanger such that the pressure of the gaseous fuel is at or above the predetermined pressure upstream of pressure regulator 50.

Alternatively, gaseous fuel supply 40 can store the gaseous fuel in a gas state under compression (such as compressed natural gas) at a high pressure, such that as engine 20 consumes the fuel the pressure of the gaseous fuel upstream of pressure regulator 50 decreases. Pressure regulator 50 regulates the pressure of the gaseous fuel to a pressure suitable for introduction into engine 20 by gaseous fuel injectors 60. Gaseous fuel is distributed to gaseous fuel injectors 60 through common rail 70, which in the illustrated embodiment is shown separate from engine 20, although this is not a requirement and in other embodiments the common rail can be integrated into engine 20, for example in the form of a bore provided in the cylinder head. Gaseous fuel injectors 60 can introduce gaseous fuel directly into cylinders (not shown) of engine 20 or can introduce the gaseous fuel upstream of intake valves (not shown) of the cylinders. In alternative embodiments gaseous fuel injectors 60 can be integrated with rail 70 and fuel delivery tubes can be employed to deliver the gaseous fuel from the gaseous fuel injectors to engine 20. The gaseous fuel is ignited in the cylinders of engine 20 by a suitable ignition source, which can be a spark plug, a laser ignition device, combustion of a pilot fuel, a hot surface or glow plug, and other conventional ignition devices.

Controller 80 is an electronic controller in the illustrated embodiment and is operatively connected with gaseous fuel injectors 60 to command the injection of gaseous fuel. Electronic controller 80 can be operatively connected with gaseous fuel supply 40 and pressure regulator 50 to command their operation and to receive status signals accordingly. Gaseous fuel mass flow sensor 100 is affixed to or within (embedded or recessed) inner surface 75 of rail 70 and sends signals to controller 80 representative of gaseous fuel mass flow between pressure regulator 50 and fuel injectors 60. In the illustrated embodiment mass flow sensor 100 is shown operatively arranged in common rail 70. In other embodiments the mass flow sensor can be arranged upstream of rail 70, such as in conduit 55 or between conduit 55 and rail 70. Alternatively, mass flow sensor 100 can be arranged upstream of pressure regulator 50, but in exemplary embodiments the mass flow sensor is arranged closer to the fuel injectors to improve the accuracy of mass flow measurements related to gaseous fuel flow through the injectors. In still further embodiments, there can be a mass flow sensor for each injector 60, as illustrated by gaseous fuel mass flow sensors 100a through 100d, in which case sensor 100 is not required.

Pressure sensor 90 sends signals representative of gaseous fuel pressure in rail 70 to controller 80, and temperature sensor 95 sends signals representative of gaseous fuel temperature pressure in the rail to the controller. Gaseous fuel pressure and temperature are relatively equal throughout rail 70, although this depends upon the application and the specific geometry of the common rail; it is possible that there can be differences in pressure along the rail and temperature along the rail during transient conditions, in which case additional pressure and temperature sensors can be employed to obtain additional measurements in different regions of the common rail.

Alternatively, gaseous fuel temperature can be determined indirectly from other parameters such that gaseous fuel temperature sensor 95 is not required. Controller 80 receives signals and/or information from other conventional sensors employed in internal combustion engines as represented by data input 85. Some examples of additional sensors include mass air flow sensor, oxygen sensor, NOx sensor, crank angle sensor and CAM angle sensor. In other embodiments, some measured parameters (such as rail temperature) can be determined indirectly from other measured parameters.

Controller 80 can include both hardware and software components. The hardware components can comprise digital and/or analog electronic components. In the embodiments herein controller 80 includes a processor and memories, including one or more permanent memories, such as FLASH, EEPROM and a hard disk, and a temporary memory, such as SRAM and DRAM, for storing and executing a program. As used herein, the terms algorithm, method, module and step can refer to an application specific integrated circuit (ASIC), an electronic circuit, a processor (shared, dedicated, or group) and memory that execute one or more software or firmware programs, a combinational logic circuit, and/or other suitable components that provide the described functionality.

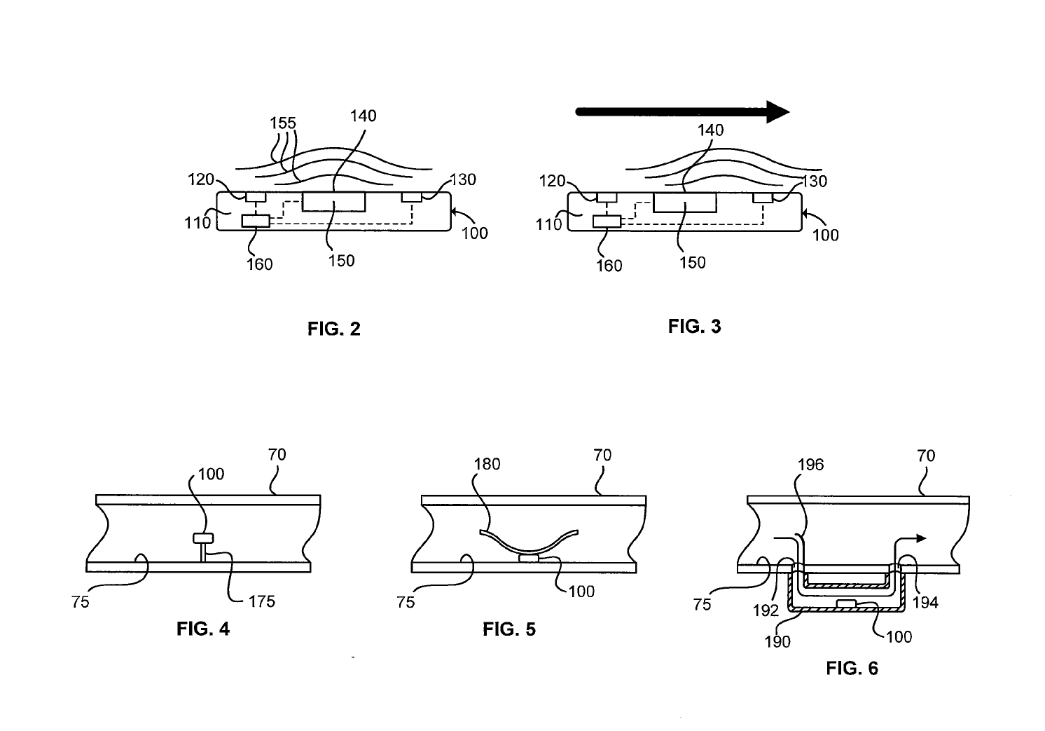

With reference now to FIGS. 2 and 3, mass flow sensor 100 is described in more detail. Mass flow sensor 100 includes membrane 110 upon or within which is temperature sensor 120 and temperature sensor 130 on mass flow sensing surface 140. Heater 150 is integrated into the center of membrane 110 between temperature sensors 120 and 130, and is commanded to maintain a constant temperature. In an exemplary embodiment, mass flow sensor 100 includes controller 160 that is operatively connected with temperature sensors 120 and 130, heater 150 and controller 80 (seen in FIG. 1). Controller 160 can be a microcontroller that includes input and output interfaces, a processing unit, a memory unit including program memory (ROM, PROM, E²PROM, FLASH) and random access memory (SRAM, DRAM), or an application specific integrated circuit that provides the required functionality. Alternatively, in other embodiments controller 80 can be operatively connected with heater 150 and temperature sensors 120 and 130 such that controller 160 is not required. In another exemplary embodiment, mass flow sensor 100 is a micro-electro-mechanical (MEMS) device that can be fabricated down to a microscopic size. Mass flow sensor 100 is substantially tolerant to gaseous fuel mass flow rates common in conventional internal combustion engines. When there is no gaseous fuel mass flow over surface 140, as illustrated in FIG. 2, the heat generated by heater 150 radiates symmetrically outwards with respect to temperature sensors 120 and 130, as illustrated by thermal gradient lines 155. However, when gaseous fuel flows over surface 140, as illustrated in FIG. 3, upstream temperature sensor 120 cools at a different rate compared to downstream temperature sensor 130. The difference between the upstream temperature and the downstream temperature is directly related to the mass flow of gaseous fuel over sensing surface 140. Mass flow sensor 100 can measure gaseous fuel mass flow in either direction; that is when gaseous fuel flows from temperature sensor 120 to 130, or from temperature sensor 130 to 120, and the terms upstream and downstream are relative to the instantaneous direction of gaseous fuel flow over sensing surface 140.

Mass flow sensor 100 can be used to measure air mass flow in an air-intake system of engine system 10. However, there are important differences between measuring air mass flow and gaseous fuel mass flow in engine system 10. Internal combustion engines operate with a variety of air-fuel ratios depending upon a number of factors including the ignition mechanism. A spark-ignited engine typically operates at or near a stoichiometric air-fuel ratio with a lambda value of 1.0, whereas as a dual fuel engine employing compression ignition of a pilot fuel operates with a lean air-fuel ratio, typically between 1.1 and 1.4. When the gaseous fuel is natural gas, the stoichiometric air-fuel ratio by mass is approximately 17.2. The mass flow of air is then 17.2 times that of the gaseous fuel (natural gas) in a stoichiometric engine, more than an order of magnitude greater, and can be as high as 24 in a lean engine operating at a lambda value of 1.4. The heat capacity of air is typically less compared to typical gaseous fuels, such that it takes less heat to increase (add heat) or decrease (remove heat) the temperature of air compared to gaseous fuels. Mass flow sensors that detect in some way the cooling effect of the mass flow, such as mass flow sensor 100, are therefore better able to detect the flow of air compared to gaseous fuels with regard to the heat capacity of these substances. As an example, the isobaric mass heat capacity (CP) of dry air is around 1.0035 Jg−1K−1 at 0 degrees Celsius and sea level, and for methane (the primary constituent of natural gas) is 2.191 Jg−1K−⁺1 at 2 degrees Celsius. Generally speaking, it takes twice the flow of methane compared to air to register the same temperature change as air. Due to these reasons it is a greater challenge to detect the mass flow of gaseous fuels compared to air in an internal combustion engine.

In the illustrated embodiment of FIG. 1, mass flow sensor 100 is arranged at inner surface 75 of rail 70. Referring now to FIG. 4, in alternative embodiments mass flow sensor 100 can be spaced apart from inner surface 75, for example centrally in rail 70, or in alike arrangement within the selected conduit the sensor is placed, such that an improved laminar flow of gaseous fuel flows over sensing surface 140, and turbulent boundary effects related to flow near inner surface 75 are reduced. Locating member 175 is employed to space mass flow sensor 100 apart from the inner surface. Locating member 175 is preferably shaped like a fin such that gaseous fuel flows around it with little disturbance.

Referring now to FIG. 5, in yet a further embodiment, mass flow sensor 100 can be arranged at or within inner surface 75 of rail 70 (or in a like arrangement within the selected conduit the mass flow sensor is placed) and flow redirecting conduit 180 can be employed to redirect a portion of the gaseous fuel flow occurring in a central region of rail 70. Flow redirecting conduit 180 allows a sample of gaseous fuel flow occurring at a central region of rail 70 to be sensed by mass flow sensor 100 when it is arranged at a periphery of the rail.

Referring now to FIG. 6, mass flow sensor 100 is mounted in sampling conduit 190 and is in fluid communication with an interior space of rail 70 through bores 192 and 194. Redirecting member 196 is employed to redirect gaseous fuel from a region of laminar flow within the interior space of conduit 70, such as near the center of the rail, or at least away from interior surface 75, through bore 192.

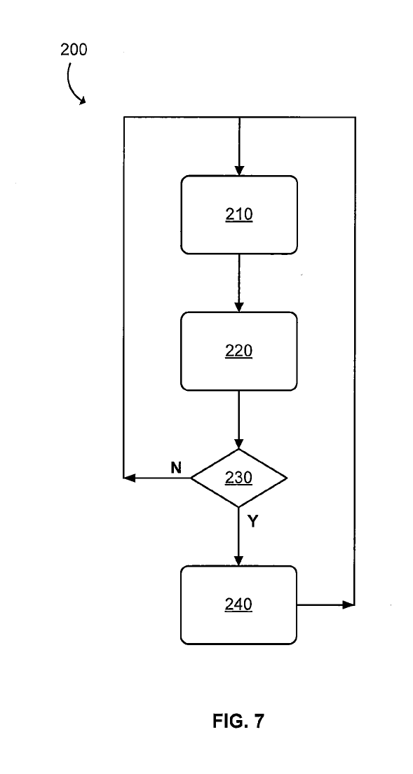

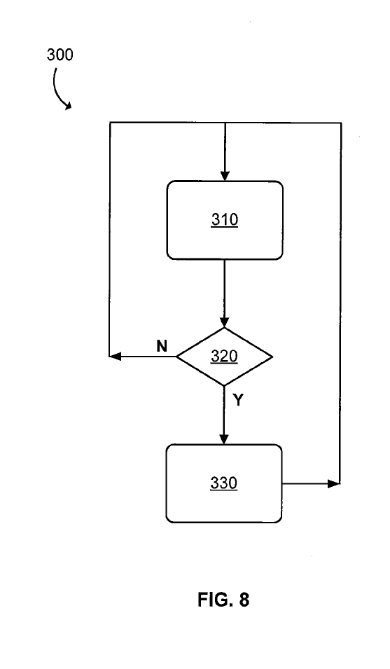

Referring now to FIG. 7, method 200 for improving gaseous fuel injector performance is now described according to a first embodiment. In step 210, mass flow sensor 100 is employed to measure the mass flow of gaseous fuel in rail 70 for each injection of gaseous fuel from injectors 60, which are each activated to inject gaseous fuel at separate points in time relative to each other. In step 220, for each injector 60, the actual injection mass of gaseous fuel is determined based on the measurements of mass flow during the injection event. Measurements of pressure and temperature in rail 70 can be employed to improve the accuracy of this determination. In step 230, the difference between the actual injection mass and the desired injection mass is calculated, for each injector. When the difference between actual and desired injection mass is greater than a predetermined value, the on-time of each injector is adjusted by adjusting the pulse width of the activation signal for each injector in step 240 such that the actual injection mass equals the desired injection mass to within a predetermined range of tolerance. The on-time of an injector generally refers to the length of time that the injector is activated by an activation signal to inject fuel. Flow profiles can be detected and analyzed in real-time, and correction models can be applied to compensate for slow opening and/or steady-state flow conditions. The pulse width adjustments can be applied during the next engine cycle. It can take one or more engine cycles to reduce the difference between the actual and desired injection masses below the predetermined value.

Referring now to FIG. 8, method 300 for improving gaseous fuel injector performance is now described according to a second embodiment. When the gaseous fuel injector is capable of partial lift, this method improves accuracy of opening the injection valve to a predetermined partial lift position. In these injectors a magnitude of the activation signal of the injector can be adjusted to change the partial lift position. The activation signal can be a voltage signal or a current signal, and the magnitude can be a voltage magnitude or a current magnitude respectively. In step 310, mass flow sensor 100 is employed to measure the actual mass flow rate of gaseous fuel in rail 70 for each injection of gaseous fuel from injectors 60, which are each activated to inject gaseous fuel at separate points in time relative to each other. In step 320, the difference between the actual mass flow rate and the desired mass flow rate is determined. When the difference between actual and desired mass flow rates is greater than a predetermined value, the magnitude of the activation signal is adjusted in step 330 such that the actual mass flow rate equals the desired mass flow rate to within a predetermined range of tolerance. The magnitude correction can be applied during the same engine cycle or the next engine cycle, and the above steps can be repeated for each engine cycle.

These techniques can be employed to compensate for fuel injectors that open more slowly than desired, which can be a result of plunger motion impeded by viscous oil, trace solids and water at low temperatures, which can be exacerbated during cold start conditions. If an injector is stuck and does not open or only opens partially when activated, such that the gaseous fuel mass flow rate through the injector is below a predetermined value, the on-time of the injector and/or the magnitude of the activation signal can be increased until the injector opens and the gaseous fuel mass flow rate is above the predetermined value. Under-flowing and over-flowing injector performance can be detected by comparing flow measurements from a number of fuel injectors that are activated at separate instances in time. An under-flowing injector has a gaseous fuel mass flow rate during an injection event that is less than an expected value. An over-flowing injector has a gaseous fuel mass flow rate during an injection event that is greater than an expected value. Actual mass flow rates for each of the injectors can be measured, and an average mass flow rate can be calculated as a function of the actual mass flow rates. When the actual mass flow rate of an injector is less than the average mass flow rate by a predetermined margin the injector is under-flowing, and when the actual mass flow rate of the injector is greater than the average mass flow rate by the predetermined margin the injector is over-flowing. For example, during high fuel flow conditions that are associated with injector activation signals that have long pulse widths occurring at relatively lower engine speeds, the fuel flow measurements from mass flow sensor 100 can be compared from injector to injector to see if any of the injectors are under-flowing or over-flowing. An under-flowing injector can be the result of a sticky needle that doesn't open all the way, or a partially blocked injection orifice(s) in the fuel injector. When the actual mass flow rates of each gaseous fuel injector are equal to within a predetermined range of tolerance, but less than the desired mass flow rate, it is possible that pressure regulator 50 is under-flowing. Mass flow sensor 100 can also be employed to detect a fuel leak in the rail when gaseous fuel mass flow is detected when none of the gaseous fuel injectors are being actuated to inject fuel. Although leaks can happen anywhere within the fuel system, when a leak is detected it can indicate that one of the fuel injectors is leaking. The performance of fuel injectors 60 and pressure regulator 50 can be assessed in real-time using mass fuel flow sensor 100 and the status of the injectors and the pressure regulator can be reported in an on-board diagnostic (OBD) system.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

1. An apparatus for operating a gaseous fuel injector in an internal combustion engine comprising:
a supply of gaseous fuel;
a conduit delivering gaseous fuel to the gaseous fuel injector from the supply of gaseous fuel;
a mass flow sensor associated with the conduit generating a signal representative of the mass flow rate of the gaseous fuel; and
a controller operatively connected with the gaseous fuel injector and the mass flow sensor and programmed to:
actuate the gaseous fuel injector to introduce gaseous fuel into the internal combustion engine;
determine the actual mass flow rate of the gaseous fuel based on the signal representative of the mass flow rate;
calculate a difference between the actual mass flow rate and a desired mass flow rate; and
adjust at least one of on-time of the gaseous fuel injector and a magnitude of an injector activation signal by respective amounts based on the difference when the absolute value of the difference is greater than a predetermined value.

2. The apparatus of claim 1, wherein the gaseous fuel injector is located to introduce the gaseous fuel directly into a cylinder of the internal combustion engine.

3. The apparatus of claim 1, wherein the controller is further programmed to adjust at least one of the on-time and the magnitude during the same cycle as the determination of the actual mass flow rate.

4. The apparatus of claim 1, wherein the mass flow sensor comprises:
a membrane;
first and second temperature sensors arranged on a sensing surface of the membrane; and
a heater connected with the membrane and arranged between the first and second temperature sensors.

5. The apparatus of claim 4, wherein the controller is operatively connected with the first and second temperature sensors to receive the signals representative of the mass flow rate of the gaseous fuel.

6. The apparatus of claim 4, wherein the controller is a first controller, the mass flow sensor further comprising a second controller operatively connected with the first controller and the first and second temperature sensors, the second controller programmed to receive temperature information from the first and second temperature sensors and to transmit the signals representative of the mass flow rate of the gaseous fuel to the first controller.

7. The apparatus of claim 1, wherein the mass flow sensor is located within the conduit.

8. The apparatus of claim 7, further comprising one of:
a flow redirecting conduit operatively arranged with the mass flow sensor to redirect a portion of gaseous fuel flow in the conduit to the mass flow sensor; and
a locating member to space mass flow sensor apart from an inner surface of the conduit.

9. The apparatus claim 1, further comprising a sampling conduit adjacent to and in fluid communication with the conduit, wherein the mass flow sensor is mounted within the sampling conduit, and a flow redirecting member in the conduit to redirect a portion of gaseous fuel flow to the sampling conduit.

10. The apparatus of claim 1, wherein the controller is further programmed to report performance of the gaseous fuel injector in a diagnostic system, wherein the performance comprises at least one of the actual mass flow rate, a rate of increase of the actual mass flow rate, a leaking indication, an under-flowing indication and an over-flowing indication.

11. A method for operating a gaseous fuel injector in an internal combustion engine comprising:
actuating the gaseous fuel injector to inject gaseous fuel;
measuring actual mass flow rate of the gaseous fuel upstream from the gaseous fuel injector;
calculating a difference between the actual mass flow rate and a desired mass flow rate; and
adjusting at least one of on-time of the gaseous fuel injector and a magnitude of an injector activation signal by respective amounts based on the difference when the absolute value of the difference is greater than a predetermined value.

12. The method of claim 11, wherein at least one of:
the on-time is adjusted during the same cycle as the measurement of the actual mass flow rate; and
the magnitude of the injector activation signal is adjusted during the same cycle as the measurement of the actual mass flow rate.

13. The method of claim 11, wherein when the actual mass flow rate is below a predetermined mass flow rate value, the method further comprises increasing at least one of the on-time of the injector and the magnitude of the activation signal until the actual mass flow rate is above the predetermined mass flow rate value.

14. The method of claim 11, further comprising:
determining the rate of increase in actual mass flow rate when the gaseous fuel injector is actuated; and
determining that the opening of the gaseous fuel injector is slow when the rate of increase is below a predetermined value;
wherein the at least one of the on-time and the magnitude of the gaseous fuel injector activation signal is adjusted to compensate for the slow opening of the gaseous fuel injector.

15. The method of claim 11, further comprising reporting performance of the gaseous fuel injector in a diagnostic system, wherein the performance comprises at least one of the actual mass flow rate, the rate of increase of the actual mass flow rate, a leaking indication, an under-flowing indication and an over-flowing indication.

16. The method of claim 11, wherein a plurality of gaseous fuel injectors are operated, the method further comprising:
calculating an average mass flow rate as a function of the actual mass flow rates for each gaseous fuel injector;
for each gaseous fuel injector at least one of:
determining whether the gaseous fuel injector is under-flowing wherein the actual mass flow rate is less than the average mass flow rate by a predetermined margin; and
determining whether the gaseous fuel injector is over-flowing wherein the actual mass flow rate is greater than the average mass flow rate by a predetermined margin.

17. The method of claim 16, further comprising determining a pressure regulator is under-flowing gaseous fuel when the actual mass flow rates for each injector are equal to within a predetermined range of tolerance and less than a desired mass flow rate by a predetermined value; and reporting the performance of the pressure regulator in a diagnostic system.

18. The method of claim 11, further comprising:
heating a space in the flow of gaseous fuel;
measuring an upstream temperature and a downstream temperature; and
calculating the actual mass flow rate as a function of a difference between the upstream temperature and the downstream temperature.

19. The method of claim 11, further comprising redirecting a portion of gaseous fuel flow in a gaseous fuel conduit towards a sensing surface of a gaseous fuel mass flow sensor.

20. The method of claim 11, wherein the gaseous fuel comprises at least one of biogas, butane, ethane, hydrogen, landfill gas, methane, natural gas, propane, and combinations of these fuels.
